(19) United States
(12) Patent Application Publication
(10) Pub. No.: US 2005/0251380 A1
(43) Pub. Date: Nov. 10, 2005

(54) Designer regions and Interactive control designers

(76) Inventors: Simon Calvert, Issaquah, WA (US); Nikhil Kothari, Sammamish, WA (US); Bulusu Krishna Mohan, Redmond, WA (US); Andrew Cheng-Min Lin, Seattle, WA (US)

Correspondence Address: LEE & HAYES PLLC, 421 W RIVERSIDE AVENUE SUITE 500, SPOKANE, WA, 99201, US

(21) Appl. No.: 10/843,543

(22) Filed: May 10, 2004

(51) Int. Cl. G06F 9/45

(52) U.S. Cl. 703/22

(57) ABSTRACT

Systems and methods for designer regions and interactive control designers are described. In one aspect, an interactive control designer receives an event from a design surface. The event is associated with graphical elements of a designer region in a server control. The server control is rendered by the design surface. The interactive control designer handles the event.

### TECHNICAL FIELD

Systems and methods of the invention relate to interactive Web server control development tools.

### BACKGROUND

Design-time environments typically include a forms designer for arranging components and a property browser for configuring the values of a component's properties. For instance, a common design paradigm is for a user to drag and drop a representation of a pre-constructed control onto a design surface. The design surface identifies and instantiates a non-interactive control designer programming object that corresponds to the dropped to control. The control designer constructs a block of static text markup (e.g., HTML) to represent graphic elements (e.g., pictures, shapes, etc.) of the dropped control. This static text markup is then provided to the design surface for rendering the graphic elements of the dropped control onto the design surface.

At this point, the control developer may desire to re-position, rotate, etc., those elements on the design surface, and/or customize (modify, add, etc.) properties/attributes of the rendered control. To customize a control's properties, the control developer typically selects the static elements representing the control of interest. This selection action causes the design surface, not the control designer, to generate and display a separate property browser dialog/properties window on top of the design surface. One of the reasons that existing control designers are not interactive is because they do not directly handle/process any events such as a design surface selection of a rendering representing a sever control.

In this example, the design surface generated property browser is used to interface with the selected control's control designer to obtain the control's properties for display in the browser, providing the control developer with access to the selected control's attributes, values, etc., for customizing, editing, replacing, and/or so on. One reason a separate property browser dialog/window is used to present and edit a pre-constructed control's properties is because the control as presented by the design surface to a developer is only composed of static graphic elements, and the control does not expose any control logic to the control developer. Instead, a preconfigured control presented on the design surface merely shows the position of the control's graphic elements on a design surface, possibly with respect to other pre-configured control graphic elements.

Unfortunately, displaying a separate property browser over the design surface that has rendered a selected control can be distracting for an end-user. This is because display of a dialog over the design surface displaces the developer's focus from the displayed control whose properties are being edited. Ideally, control properties could be customized without use of a property browser that takes the developer away from direct context of the control.

### SUMMARY

Systems and methods for designer regions and interactive control designers are described. In one aspect, an interactive control designer receives an event from a design surface. The event is associated with graphical elements of a designer region in a server control. The server control is rendered by the design surface. The interactive control designer handles the event.

### BRIEF DESCRIPTION OF THE DRAWINGS

In the figures, the left-most digit of a component reference number identifies the particular figure in which the component first appears.

FIG. 1 shows an exemplary computing device for designer regions and interactive control designers.

FIG. 2 shows an exemplary forms designer user interface.

FIG. 3 shows and exemplary editable designer region of a server control, the designer region including text that has been directly edited in place with respect to the designer region by a user without interfacing with a separate property browser dialog.

FIG. 4 shows exemplary watermark text properties of a designer region.

FIG. 5 shows an exemplary procedure for designer regions and interactive control designers.

FIG. 6 illustrates an example of a suitable computing environment on which the system of FIG. 1 and the methodology of FIG. 5 for designer regions and interactive control designers may be fully or partially implemented.

### DETAILED DESCRIPTION

Overview

The following systems and methods for designer regions and interactive control designers provide an interactive design-time environment and experience for editing a Web server control (“server control”) using region-based editing. More particularly, a display surface interfaces with the control designer to obtain markup or other data to render graphical elements of the server control. The markup specifies one or more designer regions that can be used to edit the server control. Each designer region has specific semantics that describe its behavior and functionality. Through this behavior and functionality, the designer region provides a control developer with an enhanced, interactive, and flexible interface to customize and/or select a server control. The control designer is used to interact with each relevant designer region to offer a user a context focused design-time experience when editing the server control. To this end, the control designer allows the user to directly interface with the control presented by the design surface. For example, the control designer handles any events generated by the user when the user interfaces with the server control's rendering on the design surface.

Different types of designer regions enable different behavior as a function of their respective logic design. In this implementation, for example, a designer region supports one or more of the following:
An ability to be directly editable, read-only, selectable, clickable, and highlight-able. A control developer can mark a designer region with flags for interpretation by a design-time host. This allows in-place editing, logical selection (e.g., columns within a grid control), and visual distinction of logically selected portions (regions) of the control.
Events such as click or mouse-move and drag events that allow the control designer to execute logic accordingly.
The ability to interact with the parent control, to enable further control/designer region interaction scenarios.
The ability to limit the type of content that is allowed within the designer region.
Specifying size and editing restrictions and demands.
Specifying watermarking and other descriptive indications (e.g., tooltips) to guide the application developer.

When displayed on a design surface, a developer can simply click within an editable designer region (to select that designer region) to access behavior pre-configured by the control designer to be presented to the developer responsive to control selection. With respect to an editable designer region, given the editing state of a control, for example views or templates, the control developer can implement design-time markup and related designer regions to best perform the editing of that state of the control by the user.

After selecting the editable designer region, the developer can add specific content directly into the region, for example, further server controls, static text or other traditional markup, like HTML. Such design-time selection and editing takes place directly on the design surface in a modeless fashion, enabling the developer to interact with development of a server control within the context of the page that the control is on—that is without the use of a separate properties browser window covering at least portions of the design surface. Edits are therefore performed in as close to WYSIWYG fashion as plausible, so that he context of the page is maintained.

Accordingly, designer regions take WYSIWYG design to the next-level, allowing the modification of specific portions of a control's content to be edited directly on the design-surface. Previously, application developers had to use the property grid or some form of modal dialogs to edit the content.

An Exemplary System

Turning to the drawings, wherein like reference numerals refer to like elements, the systems and methods for designer regions and interactive control designers are described and shown as being implemented in a suitable computing environment. Although not required, the invention is described in the general context of computer-executable instructions (program modules) being executed by a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

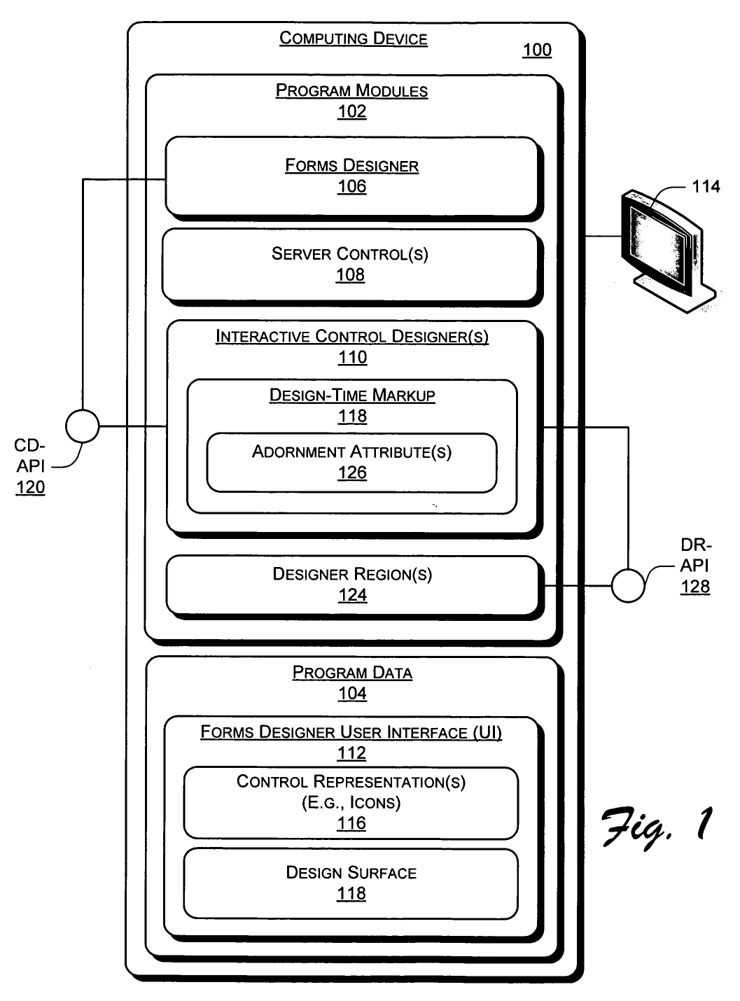

FIG. 1 shows an exemplary computing device 100 for designer regions and interactive control designers. In this implementation, computing device 100 includes program modules 102 and program data 104. Program modules 102 include, for example, forms designer 106 (a designer host), server control(s) 108, and interactive control designers 110. Forms designer application 106 implements a forms designer user interface (UI) 112 for presentation on display device 114. Forms designer UI 112 allows a user to drag and drop control representation(s) 116 onto design surface 118. Control representations 116 represent respective ones of server control(s) 108 that can be inserted onto a Web page, form (e.g., Web forms), etc., and subsequently positioned, edited, etc., by a user.

Responsive to this, design surface 118 identifies and instantiates a server control 108 associated with the selected control representation 116, and also instantiates relevant interactive control designer(s) 110. In one implementation, a relevant interactive control designer 110 is one that is referenced by an instantiated server control 108 through use of class-level metadata. The related interactive control designer(s) 110 help a user manage design surface 118 interaction with the server control 108. Interactive control designer 110 is interactive because it includes one or more event handlers to process events generated from user interaction rendered portions of the server control 108.

In this implementation, a control designer 110 has a base class of ControlDesigner. An exemplary ControlDesigner class is shown in TABLE 1.

TABLE 1
AN EXEMPLARY CONTROL DESIGNER CLASS

```
public class ControlDesigner : HtmlControlDesigner {
  string GetDesignTimeHtml(DesignerRegionCollection regions);
  string GetEditableDesignerRegionContent(DesignerRegion region);
  void SetEditableDesignerRegionContent(DesignerRegion region, string
      content);
  protected internal virtual void OnClick(DesignerRegionEventArgs e);
}
```

A control designer 110 inherits this base class from implemented design-time functionality for a server control 108. Each type of server control 108 (e.g., a Button, GridView, etc. . . . ) has an associated ControlDesigner (a respective control designer 110 such as a ButtonDesigner, GridViewDesigner, etc. . . . ). A list of exemplary types of control designers 110 is presented below in Appendix A. To modify default interactivity of a control designer 110, the control developer can override one or more of the object's methods such as GetDesignTimeHtml, GetEditableDesignerRegionContent, SetEditableDesignerRegionContent, and OnClick. Public application programming interfaces (APIs) such as the GetDesignTimeHtml ( ), GetEditableDesignerRegionContent( ), and SetEditableDesignerRegionContent( ) insterfaces are exposed by a control designer 110 via Control Designer API (CD-API) 120.

Forms designer 106 or other application(s) use CD-API 120 to access exposed interactive control designer 110 functionality. For example, the GetDesignTimeHtml interface returns a string containing design-time markup 122 for use by forms designer application 106 to represent graphical elements of the associated server control 108 on design surface 118. Design-time markup is any persistable form of rendering information, for example, markup, source code, and so on.

To illustrate this, consider that a table-based interactive control designer 110 (e.g., GridViewDesigner) may emit design-time markup 122 similar to that presented below in TABLE 2.

TABLE 2
EXEMPLARY DESIGN-TIME MARKUP

<table>
<tr>
<td _{——}designerRegion=”0”>
</td>
<td _{——}designerRegion=”1”>
</td>
</tr>
</table>

In the example of TABLE 2, design surface 118 recognizes the “_designerRegion” attributes on the <td> tags, and therefore, identifies corresponding DesignerRegion objects (designer region(s) 124) as indicated by DesignerRegionCollection, as described below in reference to TABLE 3. A designer region 124 is a logical component of a server control 108 that is independently, selectable, highlightable, etc., for user editing, interaction, and/or the like.

For purposes of discussion and exemplary illustration, such “_designerRegion” attributes are shown as adornment attribute(s) 126. When rendering design-time markup 122, adornment attribute(s) 126 indicate to design surface 118 that a particular portion of the rendering should be interpreted as a respective designer region 124. Exemplary adornment attribute(s) 126 include, for example, designer region-tag attributes with values (region tag index) to allow a designer-host (e.g., forms designer application 106) to interact with the designer region 124, such as its content or callbacks. In one implemetaiton, adornment attribute(s) 126 includes a “_designerRegionName” to allow a designer region 124 to be specified by name (rather than index).

For each instance of adornment attribute(s) 126 specified in design-time markup 122, control designer 110 instantiates, or creates, a designer region 124. Designer region object 124 has a base class of DesignerRegion, which contains properties for presentation by design surface 118. An exemplary DesignerRegion base class is now shown with respect to TABLE 3.

TABLE 3
AN EXEMPLARY DESIGNER REGION CLASS

```
public abstract class DesignerRegion {
  public bool Selected { get; set; }
  public bool Selectable { get; set; }
  public bool Highlight { get; set; }
  public virtual string Description { get; set; }
  public virtual string DisplayName { get; set; }
  public virtual string Name { get; }
  public Rect GetBounds( );
}
```

Referring to TABLE 3, “selected” interface is used to get and set the designer region 124 selection attribute. Such selection information could be useful, for example, in a tool (e.g., forms designer application 106) which shows all regions in a drop-down list and needs to display the currently selected region's name. The “selectable” interface allows forms designer application 106 to get and set a selectable attribute for the designer region 124. This is useful, for example, to present only selectable regions in a drop-down list. “Highlight” indicates that a designer region 124 can be highlighted on design surface 118 and also provide highlighted status. “Description” gives forms designer application 106 some descriptive text about the designer region 124. The descriptive text may be shown by forms designer UI 112, for example, as a forms designer application 106 based tooltip or some information tool window. “DisplayName” gives forms designer application 106 the name of the designer region 124. This name may be useful in a drop-down menu such as mentioned above. “Name” provides a unique name for the designer region 124, for example, where DisplayName might not be unique. “GetBounds” provides a control designer with the x,y coordinates, width, and height of the designer region 124 on design surface 118. In this implementation, at least a subset of this information is relevant to the 0, 0 coordinates of the control design-time. This is useful, for example, to a control developer who is painting specific regions or handling mouse clicks based on the x,y position of a user selection.

Referring to TABLE 4, an EditableDesignerRegion class inherits from DesignerRegion and provides designer region 124 editing capabilities.

TABLE 4
AN EXEMPLARY EDITABLE DESIGNER REGION CLASS

```
public abstract class EditableDesignerRegion : DesignerRegion {
  public string Content { get; set; }
  public string WatermarkText { get; set; }
}
```

The “content” interface is used to get/set information with respect to the designer region 124. For example, Design surface 118 may set the content to let control designer 110 know what new content a page developer has entered directly into the designer region 124 via design surface 118 (i.e., without the need to interface with a separate properties browser dialog/window). “WatermarkText” provides the forms designer application 106 text to render when the region's content is empty.

A designer region 124 exposes APIs such as the exemplary APIs of TABLE 3 and TABLE 4 to a control designer 106. These exposed APIs are shown as Designer Region APIs (DR-APIs) 128.

Referring above to TABLE 1, ControlDesigner.GetDesignTimeHtml interface also populates the DesignerRegionCollection with DesignerRegion instances (designer region(s) 124) corresponding to the regions defined in design-time markup 122. Using the example of TABLE 2, a table-based control designer 110 (ControlDesigner) would put two DesignerRegions into the collection corresponding to the two “_designerRegion” attributes defined in the corresponding design-time markup 122.

ControlDesigner.GetEditableDesignerRegionContent is called by forms designer application 106 when design surface 118 displays an EditableDesignerRegion (a type of designer region 124). This method queries the ControlDesigner for the content of the regions it found from GetDesignTimeHtml.

ControlDesigner.SetEditableDesignerRegionContent is called by forms designer application 106 when design surface 118 decides to commit contents of an EditableDesignerRegion that a page developer has edited. SetEditableDesignerRegionContent is called on the ControlDesigner to push the new content to the corresponding server control 108.

ControlDesigner.OnClick is called by forms designer application 106 when design surface 118 detects a mouse click or other selection event (e.g., a voice command) within the bounds of some defined region. In this implementation, DesignerRegionEventArgs contain the designer region associated with the event, the region being identified in the DTHTML. Design surface 118 passes some attributes of the click (e.g. x and y coordinates, which mouse button) to the ControlDesigner. Although a click selection event is handled by the OnClick method, another implementation of ControlDesigner includes an OnEvent method to handle substantially any event useful to the control developer for processing by the control designer 110. This would allow the control designer 110 to process many event types by routing to a particular event handler. For example, OnEvent may handle dragging, keyboard interaction, mouse movement, other UI events, and/or so on.

An Exemplary Designer-Host User Interface

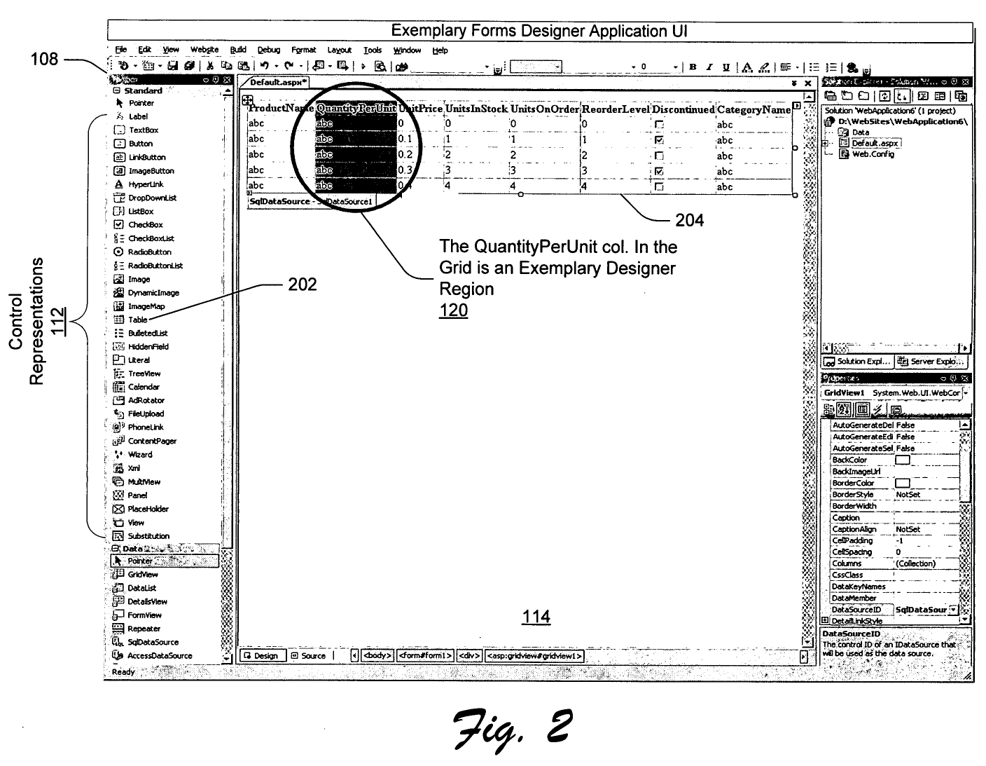

FIG. 2 shows an exemplary forms designer user interface. For purposes of discussion and illustration, the aspects of FIG. 2 are described in reference to the components of FIG. 1. In the following description, the left-most digit of a figure reference number identifies the particular figure in which the corresponding component first appears. Referring to FIG. 2, forms designer UI 112 (see also FIG. 1) includes control representations 116 representing respective ones of server control(s) 108 that can be instantiated by a user via interaction with UI 112. For instance, responsive to a user dragging and dropping a particular one control representation 114 onto design surface 118, design surface 118 instantiates the corresponding server control 108, and instantiates the associated control designer 110 (FIG. 1) to manage the design-time appearance of the sever control 108.

The instantiated control designer 110 constructs a block of design-time markup 122 adorned with attributes (adornment attribute(s) 126) defining the designer regions 124 to be shown on the design surface. Control designer 110 also populates a collection of type DesignerRegionCollection containing the designer regions 124 specified in the markup. Control designer 110 hands this information back to design surface 118. Design surface 118 parses the markup, noting any designer regions 124 provided by the collection of regions. If any of these regions include an editable designer region, e.g., of type EditableDesignerRegion, design surface 118 retrieves the initial designer region content for the region, for example, via the EditableDesignerRegion.Content interface. Design surface 118 renders the design-time markup 122, including the specified designer regions 124 and their content or watermark text.

For example, referring to FIG. 2, consider than an icon 202 representing a table-based control representation 116 is dragged and dropped onto design surface 118. In this scenario, design surface 118 interfaces with control designer API (CD-API) 120 to obtain design-time markup 122 for rendering the corresponding server control 108, which in FIG. 2 is shown as a table control 204. As shown, exemplary table control 204 includes at least one designer region 124 represented by the “QuantityPerUnit” column. Table 124 may include any number of designer regions 124 as a function of the number of designer regions 124 implemented by the table control developer. In this example, each column of table control 204 represents one or more respective designer regions 124. For example, each checkbox of the column titled “Discontinued” can be a respective designer region 124, and so on.

When performing this rendering, design surface 118 hooks-up (connects) event handlers (e.g., OnClick, OnEvent, OnMouseMove, etc.) provided by control designer 110 to handle events associated with the rendered graphical elements associated with the designer regions 124; the rendered graphical elements being presented by design surface 118. Such events include, for example, mouse movement, user selection, key presses, voice commands, etc. For example, if a page developer (i.e., a user of UI 112) clicks on a rendered designer region 124, design surface 118 detects the click, packages information about the click, and invokes an on-click method of the control designer 106 (similarly for other user gestures).

To illustrate this, consider that a user selects the “QuantityPerunit” column (a selected region) and directly edit values/attributes in the column since the QuantityPerUnit” column is of type EditableDesignerRegion class, as shown above in TABLE 4. Responsive to user selection of a region, design surface 118 sends the select event to the associated control designer 106. Responsive to receiving the event, the control designer 106 handles the selection event, for example, by determining where the click happened (in which designer region 124 the click occurred) and setting the highlight on the determined designer region 124 (e.g., via DesignerRegion.Highlight{set}). The control designer 104 may, for example, call UpdateTheDesignTimeHtml to update the designer control's associated design-time markup.

If a page developer edits content of a selected portion (i.e., a UI element such as a text box, radio control, check box, etc., provided by the control designer 110) of an editable designer region 124, the developer directly inserts, or otherwise makes the modification(s) by interfacing with the selected portion. The modification (e.g., new content) is pushed by design surface 118 back to control designer 110. The control designer pushes the modification into a corresponding control property, such as the “content” property, of the designer region 124.

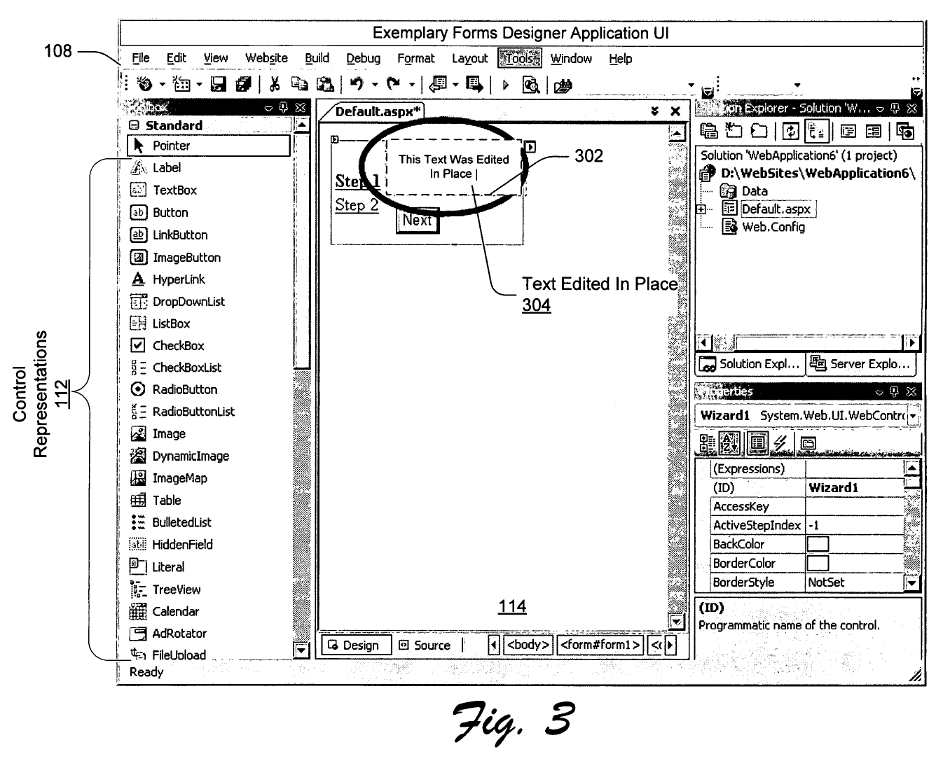

FIG. 3 shows and exemplary editable designer region of a server control. The designer region 302 is a rendering of a designer control 124 of FIG. 1. Designer region 302 includes text 304 that has been directly edited in place with respect to the graphical elements rendered for the designer region by a user. This editing is performed without interfacing with a separate property browser dialog, for example, presented by a design surface 118 or presented by any other portion of forms designer application 106. Instead, as indicated above, adornments including the UI elements for the designer region 302 are specified by the control designer 110. Text 304 is an exemplary rendering of EditableDesignerControl.Content. Since a separate property browser dialog window is not used to edit properties of a designer region, a control developer can interface with a server control 108 when editing the control's properties without a separate window being used that may take the developer's focus from the displayed control.

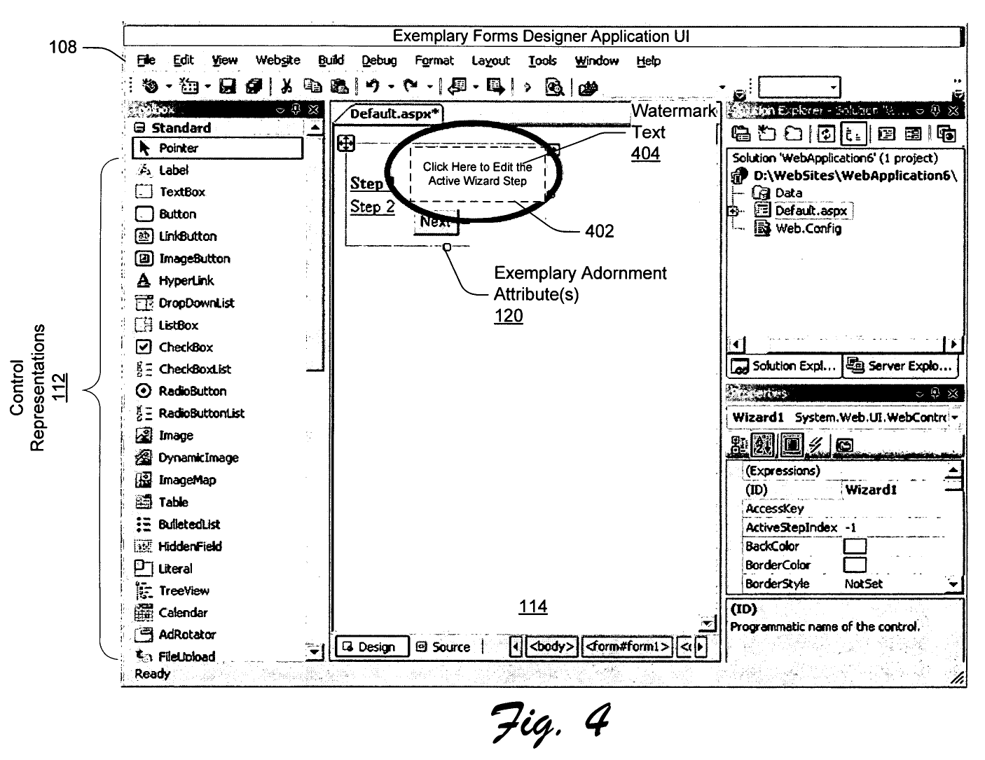

FIG. 4 shows exemplary watermark text properties of a designer region. In particular, FIG. 4 shows an editable designer region 402, of type EditableDesignerRegion, with presented watermark text 404. In one implementation, for an editable designer region 124, if the “content” attribute/property is empty, design surface 118 may render watermark text (e.g., via EditableDesignerRegion.WatermarkText{set, get}). Watermark text provides context, semantics, instructions, or any other information to a user to assist user interface with the designer region 124.

An Exemplary Procedure

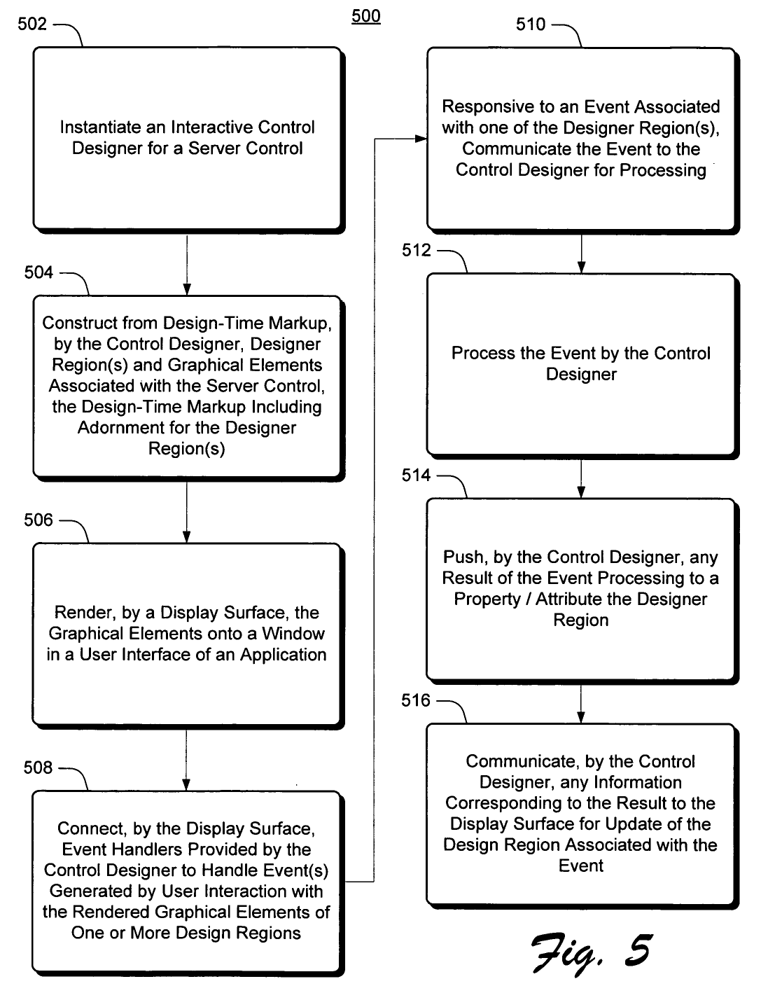

FIG. 5 shows an exemplary procedure 500 for designer regions and interactive control designers. For purposes of discussion and illustration, operations of procedure 500 are described in reference to aspects of computing device 100 of FIG. 1. In the following description of procedure 500, the left-most digit of a component reference number identifies the particular figure in which the component first appears.

At block 502, design surface 118 instantiates the corresponding server control 108 along with its associated control designer 110. For example, a user drags and drops in icon associated with a particular control representation 112 onto design surface 118. The design surface maps the selected control representation 116 to a particular server control 108 for instantiation. At block 504, control designer 110 constructs from design time markup 122 one or more associative designer regions 116 and graphical elements associative with server control 108. Respective ones of adornment attribute(s) 126 specify aspects of the graphical elements for each of the designer region(s) 124 that make up server control 108. The designer control 110 communicates this information back to design surface 118.

At block 506, design surface 118 renders the graphical elements provided by control designer 110 into a window (design surface) of user interface 112. More particularly design surface 118 parses the information provided by control designer 110, noting any designer regions 124 defined. Design surface 118 looks up the defined designer regions in a collection of regions (e.g., see, DesignerRegionCollection of TABLE 1). If any of these regions are specified as been editable (e.g., see, EditableDesignerRegion of TABLE 4), design surface 118 interfaces with control designer 110 to obtain any initial content for the editable designer region. Such initial content indicates to design surface 118 what to present inside of a defined regions 124. In one implementation, if no initial content specified a watermark text attributes of the editable designer region provides information for design surface 118 to render into the editable designer region.

At block 508, design surface 118 hooks-up event handlers provided by control designer 110 to handle events generated by user interaction with the rendered graphical elements of the one or more designer regions 124 as rendered by design surface 118. As described above in reference to TABLE 1, a control designer 110 includes one or more event handlers, for example, the ControlDesigner.OnClick event handler. At this point, the design surface is rendering of the server control 108 is now interactive because it is connected via the design surface 118 into operational characteristics of the associative control designer 110. This means that the control designer 110 participates in handling events responsive to user interaction (e.g., selection, keyboard events, editing content, announcements, and/or the like) with the rendering of the server control 108.

In view of the above, at block 510, and responsive to an event associative with one of the designer regions 124 rendered by design surface 118, design surface 118 communicates the event to the interactive control designer 110 for processing/event handling. At block 512, the control designer 110 processes the event. At block 514, control designer 110 pushes any result of the event processing to a property/attribute of the associative designer region 124 (e.g., see the SetEditableDesignerRegionContent interface of TABLE 1). This means that the control designer 110 handles any new content by directly pushing it into a property of the server control 108. At block 516, control designer 110 communicates any information corresponding to the event handling operations (result) to design surface 118. The design surface 118, responsive to receiving any such result, performs any updates to UI 112 with respect to the graphical elements presented for the designer region 124 associated with the event.

An Exemplary Operating Environment

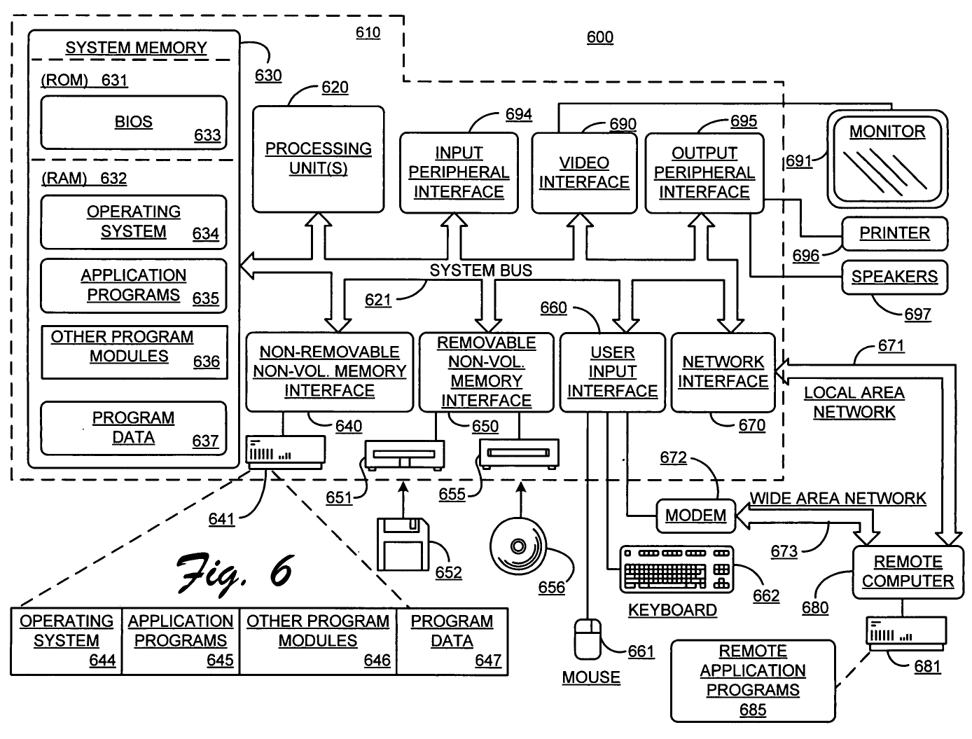

FIG. 6 illustrates an example of a suitable computing environment 600 on which the system 100 of FIG. 1 and the methodology of FIG. 5 for designer regions and interactive control designers may be fully or partially implemented. Exemplary computing environment 600 is only one example of a suitable computing environment and is not intended to suggest any limitation as to the scope of use or functionality of systems and methods the described herein. Neither should computing environment 600 be interpreted as having any dependency or requirement relating to any one or combination of components illustrated in computing environment 600.

The methods and systems described herein are operational with numerous other general purpose or special purpose computing system environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 6, an exemplary system for designer regions and interactive control designers includes a general purpose computing device in the form of a computer 610. The following described aspects of computer 610 are exemplary implementations of server 106 (FIG. 1) and/or client 110. Components of computer 610 may include, but are not limited to, processing unit(s) 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

A computer 610 typically includes a variety of computer-readable media. Computer-readable media can be any available media that can be accessed by computer 610 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or a direct-wired connection, and wireless media such as acoustic, RF, infrared and other wireless media. Combinations of the any of the above should also be included within the scope of computer-readable media.

System memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example and not limitation, FIG. 6 illustrates operating system 634, application programs 635, other program modules 636, and program data 637. In one implementation, application programs 635 include forms designer application 106, server control(s) 108, associated control designer(s) 110, and designer regions 124. In this same scenario, program data 637 includes design-time markup 122, adornment attribute(s) 126, forms designer user interfaces 112, control representations 116, and design surface 118. Program logic of user interface 112 is implemented by forms designer application 106.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that they are at least different copies.

A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus 621, but may be connected by other interface and bus structures, such as a parallel port, game port or a universal serial bus (USB).

A monitor 691 (e.g., display 910 of FIG. 1) or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 operates in a networked environment using logical connections to one or more remote computers, such as a remote computer 680. The remote computer 680 may be a personal computer, a server, a router, a network PC, a peer device or other common network node, and as a function of its particular implementation, may include many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example and not limitation, FIG. 6 illustrates remote application programs 685 as residing on memory device 681. The network connections shown are exemplary and other means of establishing a communications link between the computers may be used.

Conclusion

Although the systems and methods for designer regions and interactive control designers have been described in language specific to structural features and/or methodological operations or actions, it is understood that the implementations defined in the appended claims are not necessarily limited to the specific features or actions described. For example, referring to FIG. 1, although control designer(s) 118 have been described as presenting markup (e.g., HTML) based on design-time markup 118 to design surface 118 for subsequent rendering of graphic elements, such markup and/or design-time markup 118 need not be based on a markup language. In one implementation, such markup and/or design-time markup is any type of data that describes aspects of designer region(s) 120 and other portions of a server control 104 for used by design surface 118 or any other type of computer-program object or application to render graphic elements and hook-up event handlers associated with the corresponding control designer 106. Accordingly, the specific features and actions of the detailed description and accompanying drawings are disclosed as exemplary forms of implementing the claimed subject matter.

### APPENDIX A: TABLE OF CONTENTS

1. Overview

This appendix describes the features available for both tool (designer-host) and control developers to provide design-time features for web controls.

Design-time functionality for a control is handled through control designers which interact with the designer=host and are associated to the underling control itself. For purposes of discussion of the following exemplary description in appendix A, and referring to FIG. 1, a designer host, host, or tool is an application, which is shown as exemplary forms designer 106 of FIG. 1, a server control or control is a server control 108, a control designer or designer is an interactive control designer 110, a region or designer region is a designer region 124, and so on.

Control Designers Provide:
Design-time rendering and content for the associated control, for example, an ASP.NET control. The rendering can be complex or take on many forms, such as column editing, template editing (<asp: Grid View) or multiple runtime views on the control (<asp:PasswordRecovery).
Component UI for property editing or type editing

The described interactive control designer architecture provides, for example:
Region-based editing support, for finer-grained WYSIWYG editing in a designer-host. The control-developer can subscribe to and handle events on regions with the deign-time layout for a control.
The ability to subscribe to and utilize a number of services offered through the host such as access to data, configuration and the ability to programmatically add to the page.

2. Scenarios

The following exemplary scenarios are illustrated:
Design-time Hosting and Editing of Controls. (region-based editing, task-based editing)
Tool-Developer Adds Support for Web Controls and Defines Their Own Consistent UI
Control designer Extensibility

Many of the scenarios are described below in the section titled “How Tos.”

3. Specification

Interactive Control Designers

There are a number of classes and interfaces that are defined in this spec that meet two distinct audiences:
Developers who want to provide designer-host or tool support for ASP.NET controls
Developers who want to provide design-time support for a web control in a designer-host.

The following exemplary simple example shows a simple control designer for a TAB control that uses the control to produce the rendering. The rendering for the control is adorned with region-tag attributes. The attribute value (region tag index) allows the designer-host to interact with the region, such as its content or callbacks.

The following exemplary sample shows a design-pattern as the tool implementation will call a new method on the control designer base class that performs the work of handling the exception and clearing any regions collection. It will also call on error and empty design-time htm1 methods.

```
// ---------------------------------------------------------
// The design-time layout creates regions to fill the region collection
// which match the regions in the layout.
public class MyTabControlDesigner: ControlDesigner
{
  ...
  private int _selectedPage = 0;
  private int _numTabs = 2;
  public string SelectedPage
  {
    get { return _selectedPage; }
    set {
      // Setting this property to a new value causes the control designer
      // to tell the designer-host to update the rendering
      if (_selectedPage != value )
      {
        _selectedPage = value;
        UpdateDesignTimeHtml( );
      }
    }
  }
  protected override void OnClick(object sender,
  DesignerRegionEventArgs e)
  {
    SelectedPage = e.Region.Name;
  }
  public override string GetDesignTimeHtml(DesignerRegionCollection
  regions)
  {
    String dtHtml;
    // Create regions for each of the buttons or TABS
    // Create region for the currently selected page
    // Add attributes for the region index to the child controls
    dtHtml = base.GetDesigntimeHtml( );
    return dtHtml;
  {
  public override string GetEditableDesignerRegionContent(
      EditableDesignerRegion region)
  {
    MyTabControl control = (MyTabControl)Component
    // Get the tab itself, which is a panel in the collection
    Panel p = control.FindControl(region.Name);
    // obtain the persisted form of the controls contained in the panel
    return ControlSerializer.SerializeControl(ServiceProvider,
    p.Controls);
  }
  public ocverride void SetEditableDesignerRegionContent(
      EditableDesignerRegion region, string content)
  {
    // The host will fill the content string with new content
    // based on updates. Push the content back to the control..
    Control{ } controls =
      ControlParse.ParseControl(content, HoswtDesigner);
    MyTabControl control = (MyTabControl)Component
    // Get the tab itself, which is a panel in the collection
    Panel p = control.FindControl(region.Name);
    p.Controls.Clear( );
    p.Controls.AddRange(controls);
  }
}
```

The implementation above creates, for example, the following exemplary HTML string in the GetDesignTimeHtml ( . . . ) method. The <DIV> content is an editable region with content defined. Note: that the region returns strings representing the controls therein which the host will interpret and create control designers for.

<TABLE><TR><TD _{——}desginerRegion=’1’>
<INPUT TYPE=’Button’ Value=’Tab:1’></INPUT>
</TD></TR></TABLE>
<DIV _{——}desginerRegion =’2’></DIV>

The designer-host obtains details about each region through the attribute adorning the layout (e.g., adornment attribute(s) 122 of FIG. 1). The above region (1) for the TAB is a clickable region, (readonly). The host also calls back on the control designer to obtain the content for the editable region (2) defining the tab-page

<!- Arbitrary content here -->
<asp:Label runat=’server’ Text=’Hi there TAB control’>

Region-Based Editing:

Control developers are given a rich model to provide granular-level editing support in designer-hosts that understand region-based editing. The developer implements methods on the control designer to provide regions. If the tool supports regions, then the method will be called.

SupportsRegions Therefore Infers:
The designer-host renders region-based layout for the control as the primary interaction. The control developer provides all layout.
The control developer creates a DesignerRegionCollection which defines granular editing. Regions allow the control designer to handle:
   Mouse-events such as mouse-over, drag and drop and click events can be handled in the control designer. Events are provided in the control designer base class, which can be overridden by the developer.
   Editing directly in the design-surface. Regions can define their content to be ServerControlsOnly, which means that any entered HTML is not preserved in that region.
   The tool is used to strip out any content in the string of content for a region at the top-level that is not a server-control tag. Any arbitrary text or markup between server-tags is allowed however.
Regions are marked on certain elements within the rendering (using the notation <attributeName>=“<indexvalue>”. The attribute is a string known to the designer, and is not a regular HTML attribute.
   The region-based index value is 0-based.

In the implementation the developer creates a regions collection, adding regions (DesignerRegion or EditableDesignerRegion, and inferred selectable or clickable regions). The layout is adorned with indexes to identify each ‘container’ with a region. The following exemplary sample displays the notion of the attribute for a control's design-time HTML.
<span_designerRegion=“1”>Label-Text</span>

The designer-host obtains a guaranteed synchronized, region collection that supports the design-time layout provided by the control designer. The designer-host is able to call upon the indexed region to obtain a number of details about the regions. In particular, the hoist obtains the content for the region.

By default, an EditableDesignerRegion delegates its Content property {get; set;} to the parent control designer's GetEditableDesignerRegionContent and SetEditableDesignerRegionContent methods. In this way, the developer does not implement custom EditableDesignerRegions to handle the content, but rather deals with implementation through the methods on ControlDesigner. In terms of extensibility however, the control developer is at liberty to create a custom EditableDesignerRegion and override the delegation.

Region-Based Editing Adorner

The following exemplary HTML/XHTML elements are defined as valid elements that are recognized by a design-time. These are typically container-type elements that can contain arbitrary HTML tags and content. However, regions can be readonly, or geared towards text only.

| Element | Sample | Notes |
|---|---|---|
| <SPAN> | <SPAN _{——}desginerRegion=”1”> | Span |
| | Any content | |
| | </SPAN | |
| <DIV> | <DIV _{——}desginerRegion=”1”> | Div |
| | Any content | |
| | </DIV> | |
| <TD> | <TR> | Table cell |
| | <TD _{——}desginerRegion=”2”> | |
| | Any content | |
| | </TD> | |
| | </TR> | |
| <TH> | See table cell | Table cell head |
| <CAPTION> | | |
| <LABEL> | | |
| <A> | | |
| <CENTER> | | |
| <DIR> | | |
| <BLOCKQUOTE> | | |
| <ADDRESS> | | |
| <PRE> | | |
| <P> | <P _{——}desginerRegion=”1”> | Paragraph |
| | Any content | |
| | </P> | |

Handling Events on Controls:

The region-based controls allow the control designer to interact with user-click or mouse actions. Events are defined at the control-level, and will in their EventArgs define the region that the event occurred on.

Internally, events are funneled through the View property. The View implements a ViewEvent handler for all events and calls the appropriate method on the control designer.
A control developer has the opportunity to create a variety of effects on the design-surface when handling specific events, or event combinations, such as the ability to provide cursors, drag and drop, or click events.
Control-developers can mimic combinations of events for specific scenarios, however, a generic OnClick (which occurs after a mouse-up), is defined for simplicity.

Click Event

The click event on the control performs a number of effects:
It is fired in the tool on mouse-up and accounts for the normal wobble rectangle around the click (down-up)
The control is selected in the design-surface if not already, this also means that the nested control becomes selected if clicked

The click event on the designer passes an argument of type DesignerRegionEventArgs, from which the developer can determine the region that was clicked. In response to this therefore the developer can set regions to be selected, highlighted etc.

Developers call UpdateDesigntTimeHtml for the host to redraw and highlight the marked regions.

Control Persistence and Control Parsing:

Control designers have a simplified helper classes for parsing and persistence of controls, ControlPersister and ControlParser. Control developers make use of these to parse and persist content to the associated control for a control designer.

For example, where a region represents a container into which controls can be added. The designer-host does not take the final rendering of the controls, but the string that represents the persistence of the control collection, so that the child controls designers are instantiated and used.

The persisting and parsing of controls also includes the understanding of device-filters. This is accomplished through the use of the service IFilterResolutionService.

Designer-Region Base Classes:

System.Web.UI.Design.EditingContentType:

The content-type is used to mark an EditableDesignerRegion. The designer-host interprests the type for its own handling.

```
public enum EditingContentType {
  TextAndMarkup = 0,
  TextOnly = 1
}
```

System.Web.UI.Design.DesignerRegionCollection:

```
public sealed class DesignerRegionCollection : IList
{
  bool IList.IsFixedSize { get;}
  bool IList.IsReadOnly { get; }
  object IList.this[int index] { get; set; }
  int IList.Count { get; }
  bool IList.IsSynchronized { get; }
  object IList.SyncRoot { get; }
  int IList.Add(object o);
  void IList.Clear( );
  bool IList.Contains(object o);
  int IList.IndexOf(object o);
  void IList.Insert(int index, object o);
  void IList.Remove(object o);
  void IList.RemoveAt(int index);
  void IList.CopyTo(Array array, int index);
  public int Count { get; }
  public DesignerRegion this[int index] { get; set; }
  public ControlDesigner Owner { get; }
  public Add(DesignerRegion region);
  public void Clear( );
  public bool Contains(DesignerRegion region);
  public int IndexOf(DesignerRegion region);
  public void Insert(int index, DesignerRegion region);
  public void Remove(DesignerRegion region);
  public void RemoveAt(int index);
  IEnumerator IEnumerable.GetEnumerator( );
  public DesignerRegionCollection(ControlDesigner owner);
}
```

Methods:

DesignerRegionCollection: See Region-based Editing, ControlDesigner,
ControlParser/ControlPersister

| | |
|---|---|
| Description | Constructor. The region collection takes a reference |
| | to the ControlDesigner control designer. |

Add: See Region-based Editing, ControlDesigner,
ConrolParser/ControlPersister

| | |
|---|---|
| Description | Adds a region to the list. |
| Clear | |
| Description | Removes all regions from the list. |
| Contains | |
| Description | Returns true if the list contains the specified region. |
| IndexOf | |
| Description | Returns the index of the specified region in the list. |
| Insert | |
| Description | Returns the intex of the specified region in the list. |
| Remove | |
| Description | Removes the specified region from the list. |
| RemoveAt | |
| Description | Removes the region from the list at the specified index. |
| IList.Add | |
| Description | Adds a region to the list. |
| IList.Clear | |
| Description | Removes all regions from the list. |
| IList.Contains | |
| Description | Returns tru if the region is contained in the list. |
| IList.IndexOf | |
| Description | Returns the index of the specified region in the list. |
| IList.Insert | |
| Description | Adds a specified region to the list at the specified index. |
| IList.Remove | |
| Description | Removes a specified region from the list. |

IList.RemoveAt

| | |
|---|---|
| Description | Removes a specified region from the list. |
| IList.CopyTo | |
| Description | Copies the region list to the specified array from the |
| | given index. |

IEnumerator.GetEnumerator

| | |
|---|---|
| Description | Returns an enumerator. |

Properties:

| | |
|---|---|
| IList.Count | |
| Description | Returns the count of regions in the list. |
| IList.SyncRoot | |
| Description | |
| IList.IsSynchronized | |
| Description | |
| IList.IsFixedSize | |
| Description | |
| IList.IsReadOnly | |
| Description | |
| Count | |
| Description | Returns the count of regions in the list. |
| This | |
| Description | Indexer. |
| Owner | |
| Description | Returns the ControlDesigner that the region list |
| | belongs to. |

System.Web.UI.Design.DesignerRegion:

```
public abstract class DesignerRegion
{
  public static readonly string DesignerRegionAttributeName;
  public DesignerRegion(ControlDesigner designer, string name);
  public Rect GetBounds( );
  public ControlDesigner Designer { get; }
  public object UserData {get; set; }
  public bool Selected { get; set; }
  public bool Selectable { get; set; }
  public bool Highlight { get; set; }
  public virtual string Description { get; set; }
  public virtual string DisplayName { get; set; }
  public virtual string Name { get; }
}
```

Methods:

DesignerRegion: See Region-based Editing, ControlDesigner,
Controlparser/ControlPersister

| | |
|---|---|
| Description | Constructor. |
| GetBounds: | |
| Description | Returns a Rect that represents the co-ordinates of the |
| | region relative to the control designer. Typically, this may |
| | be used to invalidate and paint the area of the region on |
| | the design-surface. |
| | If the control or its region is clipped by the design- |
| | surface, the Rect is unaffected. |

Properties:

DesignerRegionAttributename:

| | |
|---|---|
| Description | The string that is used to mark the designtimeHtml for |
| | region based editing. I_desigenrRegion) |

Designer: See Region-based Editing, ControlDesigner,
ControlParser/ControlPersister

| | |
|---|---|
| Description | The control designer. |

Enabled: See Region-based Editing, ControlDesigner,
ControlParser/ControlPersister

| | |
|---|---|
| Description | Marks whether the region is enabled or not. Default is |
| | true. |

Description: See Region-based Editing, ControlDesigner,
ControlParser/ControlPersister

| | |
|---|---|
| Description | Used to describe the region. The designer-host may |
| | utilize this property for tool-tip. |
| DisplayName: | |
| Description | A specific name that can be associated with the region |
| | that the designer-host may use to provide UI for. |

Name: See Region-based Editing, ControlDesigner,
ControlParser/ControlPersister

| | |
|---|---|
| Description | Used to name the region. |
| UserData | |
| Description | Allows the region to define an object for that region. |
| Selectable: | |
| Description | Default = false |
| | Indicates whether the can be selected. Selected regions |
| | may be used to define a logical group of regions. For |
| | example a click on a column cell where the column is |
| | represented by a header and a number of cells, my mark |
| | the region representing the header as selected. Only |
| | selectable regions can be marked as selectad = true. |
| Selected: | |
| Description | Default = false |
| | Indicates whether the region is selected by the page |
| | developer. Typically control-developers will set this flag |
| | and use as a marker on a region. Tools may special case |
| | UI on the basis of a selected region. |
| | A selected region may logically represent more than one |
| | region, see Selectable. |
| Highlight: | |
| Description | Default = false |
| | Regions that are marked highlight = true will be treated |
| | specially by the tool, which will paint a highlight |
| | over the region and its content. |
| | EditableDesignerRegions also specify a watermark. If the |
| | region contains no content, then the watermarking is |
| | shown over the region and is independent of the highlight |
| | flag. |
| | If a an EditableDesignerRegion is UI activated, the |
| | highlight field may not be honored. |

System.Web.UI.Design.ClickableDesignerRegion:

```
public sealed class ClickableDesignerRegion : DesignerRegion
{
  public ClickableDesignerRegion (IDynamicControlDesigner owner,
string name);
  public bool IsSelected { get; set; }
  public void Click(MouseEventArgs e)
}
```

Methods:

| ClickableDesignerRegion: | |
|---|---|
| Description | Constructor |

Properties:

| | |
|---|---|
| IsSelected: | |
| Description | Indicates whether the region has been selected by the |
| | page developer. |
| Click: | |
| Description | Called by the designer-host. Calls on the handler OnClick |
| | in the control designer |

System.Web.UI.Design.SelectableDesignerRegion:

public sealed class SelectableDesignerRegion : ClickableDesignerRegion
{
public SelectableDesignerRegion (IDynamicControlDesigner owner,
string name);
}

Methods:

| SelectableDesignerRegion: | |
|---|---|
| Description | Constructor |

System.Web.UI.Design.EditableDesignerRegion:

```
public class EditableDesignerRegion : DesignerRegion
{
  public EditableDesignerRegion(ControlDesigner owner, string name);
  public EditableDesignerRegion(ControlDesigner owner, string name,
    bool serverControlsOnly);
  public virtual ViewRendering GetChildViewRendering(Control control);
  public Type ContainerType { get; set; }
  public virtual string Content { get; set; }
  public string WatermarkText { get; set; }
  public bool ServerControlsOnly { get; set; }
  public virtual bool SupportsDataBinding { get; set; }
}
```

Methods:

EditableDesignerRegion: See Region-based Editing

| | |
|---|---|
| Description | Overloaded, constructor. |

GetChildViewRendering

| | |
|---|---|
| Description | Returns a ViewRendering that contains the content and |
| | regions of a child control. The call to this method is made |
| | through a child control within the editabledesignerregion, |
| | This allows the parent (the control with the |
| | editabledesignerregion), to adorn the child control and |
| | call on the child for design-time markup etc. |

Properties:

ContainerType: See Region-based Editing, ControlParser/
ControlPersister r

| | |
|---|---|
| Description | The control type that is the container that the editable |
| | region represents. The ContainerType is used in |
| | databinding child controls in the editable region. |
| Content | |
| Description | Provides the content for this particular region. |

ServerControlsOnly: See Editing Constraints on EditableDesignerRegions

| | |
|---|---|
| Description | Default is false. When true, the designer-host will ensure |
| | that any content that is passed to SetContent for a specific |
| | region will not contain arbitrary text or HTML, such as |
| | <br> &nbsp; etc. |

WatermarkText: See Watermarking Regions

| | |
|---|---|
| Description | Used to set a watermark on the region, if the designer- |
| | host supports watermarking. The watermark text and |
| | colorization by the tool is typically only presented when |
| | the region contains no content. |

SupportsDataBinding:

| | |
|---|---|
| Description | Used to state whether the region supports databinding. If |
| | a region does support databidning, then the databindings |
| | dialog will be displayed for the control. The base |
| | ControlDesigner's DataBindingsEnabled property is |
| | dependant upon the region that the control is within for |
| | example. |

System.Web.UI.Design.ViewEventHandler:

Events raised on the design-surface (on the View) are routed to the handlers on the Control designer. The event handler is generic enough that new events can be added to this interface, by the implementation handling a simple eventType enum.

The event handler in the View takes the following exemplary signature

public delegate void ViewEventHandler(object sender, ViewEventArgs e); System.Web.UI.Design.ViewEvenArgs:

```
public sealed class ViewEventArgs : EventArgs
{
  public ViewEventArgs(ViewEvent eventType, DesignerRegion region,
    EventArgs e);
  public DesignerRegion Region { get; }
  public ViewEvent EventType { get; };
  public EventArgs EventArgs { get; }
}
```

Methods:

| ViewEventArgs | |
|---|---|
| Description | Constructor. Takes a DesignerRegion and eventType |

Properties:

DesignerRegion

| | |
|---|---|
| Description | The DesignerRegion associated with the event.. |
| EventType | |
| Description | Object that represents the type of event, see ViewEvent. |
| EventArgs | |
| Description | Contained eventArgs |

```
System.Web.UI.Design.ViewEvent
public sealed class ViewEvent
{
  private ViewEvent( );
  public static readonly ViewEvent Click;
  public static readonly ViewEvent Paint;
  public static readonly ViewEvent TemplateModeChanged;
}
System.Web.UI.Design.ViewFlags:
[flags]
public enum ViewFlags
{
  Custompainting = 0x1;
  DesignTimeHtmlRequiresLoadComplete= 0x2;
  TemplateEditing = 0x4;
}
```

4. How-Tos:

Control Designer Developers

As defined previously, there are a number of interfaces and base classes that a control designer author has at their disposal. The following exemplary dub-sections provide samples for exemplary scenarios.

Region-Based Editing: ControlDesigner, ControlPersister, ControlParser:

Step1: GetDesignTimeHtml(DesignerRegionsCollection regions) is the central method that the control-developer implements to provide the layout and content for the control. The following exemplary general pattern is defined:
Step 1.1: Ensure that the associated control is properly initialized, for example checking the underlying Component type
Step 1.2: Implement DesignerRegions and add these to a collection if required. The developer may ensure that the collection and the use of these in the layout are in sync.
   For editable regions the region may return a string of content representing the persistence of the content for that region.
Step 1.3: Generate the HTML layout for the design-surface for the control, either
   The base. GetDesignTimeHtml( ) calls on the associated control's RenderControl( ).
   The developer constructs the layout directly.
Step 1.4: Adorns any layout with region-tag indexes. There are several ways that the developer can perform this task:

Add the region-tag attribute to any child control's for the underlying control prior to base. GetDesignTimeHtml( ).

```
// -----------------------------------------------------------------------------
// Sample: Initialize, checking that the control is a container
//
public override string Initialize(IComponent component)
{
    if(!(component is Control) && !(component is INamingContainer))
      throw new ArgumentException( “ be a Container”, “component”);
    base.Initialize(component);
}
// -----------------------------------------------------------------------------
// Sample: generating rendering within the control designer directly
//
public override string GetDesignTimeHtml(out DesignerRegionCollection
regions)
{
    String dtHtml;
    // Create a simple column, click region at top and edit region below
    regions = new DesignerRegionCollection( );
    regions.Add(new DesignerRegion(this, “Header”);
    regions.Add(new EditableDesignerRegion(this, “body”);
    // Build the layout for the design-time
    StringBulder sb = new StringBulder( );
    sb.Append(“<TABLE><TR><TD _{——}desginerRegion” +
region[0].AttributeValue +
        “’></TD></TR>”);
    sb.Append(“<TR><TD _{——}desginerRegion=’
        “ + regions[1].AttributeValue + “’> </TD></TR></TABLE>”;
    dtHtml = sb.ToString( );
    return dtHtml;
}
// -----------------------------------------------------------------------------
// Sample: using the control's control collection for creating the layout for
// the control designer
//
public override string.GetDesignTimeHtml(DesignerRegionCollection
regions)
{
    String dtHtml;
    MyControl control = (MyControl)Component;
    // Make sure that the control has created its child controls
    // by accessing the control collection
    ControlCollection controls = control.Controls;
    regions.Add(new DesignerRegion(this, “Header”);
    regions.Add(new EditableDesignerRegion(
        this, “body”);
    // Build the rendering for the design-time.
    // The child controls are known to be table cells at specific
    // locations in the collection
    control.Controls[2].Attributes.Add(
      DesignerRegion.DesignerRegionAttributeName, “0”);
    control.Controls[4].Attributes.Add(
      DesignerRegion.DesignerRegionAttributeName, “1”);
    dtHtml = base.GetDesignTimeHtml( );
    return dtHtml;
}
```

Step

2: GetEditableDesignerRegionContent(EditableRegion).and.SetEditableDesigner RegionContent(EditableDesignerRegion region, string content) are implemented by the developer.
Step 2.1: The designer-host can obtain the content for any edit region through GetEditableDesignerRegionContent which the control developer implements. The developer return to the control to obtain the content for the region. This may be a property on the control, such as Text, or may be the persisted form of the controls that are within the container.

Step 2.2: The developer updates any new content for the region to the control itself. The designer-host calls SetEditableDesignerRegionContent when content needs to be saved. As above, the content either sets a property on the control or adds a new persisted form of the controls into the container the region represents.

```
public override stringGetEditRegionContent(EditRegion region)
{
  MyControl control = (MyControl)Component
  // The edit region represents a container which is a Panel in this case
  Panel p = control.FindControl(“body”);
  // Obtain the persisted form of the controls contained in the panel
  // and send it back to the designer-host
  return ControlPersister.PersistControl(p.Controls, HostDesigner);
}
public override void SetEditableDesignerRegionContent(
    EditableDesignerRegion region, string content)
{
  MyTabControl control = (MyTabControl)Component
  // The host will fill the content string with new content
  // based on updates. Push the content back to the control.
  Control{ } controls =
    ControlParser.ParseControl(content, DesignerHost);
  // Now that we have the control array, add this to the container
  Panel p = control.FindControl(region.Name);
  p.Controls.Clear( );
  p.Controls.AddRange(controls);
}
```

Watermarking Regions, Describing Regions

EditableDesignerRegions can provide text that the designer-host can treat separately from the region's content itself. Watermark text is generated typically in the design-surface. Watermark text is simply a property on the EditableDesignerRegion.

// Create a simple column, click region at top and edit region below
regions = new DesignerRegionCollection( );
// Non-editable region
regions.Add(new DesignerRegion(this, “Header”);
// Create editable region with watermark text
EditableDesignerRegion edr = new EditableDesignerRegion(this, “body”);
sdr.WatermarkText = “Click and edit or drag and drop controls”;
regions.Add(edr);

DesignerRegions can also provide simple descriptions. The designer-host can provide the Description text typically in the form of a tool-tip on the region
EditableDesignerRegion edr=new EditableDesignerRegion(this, “body”);
sdr.Description=“This region represents the body of the column”;

Editing Constraints on EditableDesignerRegions:

EditableDesignerRegions can describe the type of editable content they will accept through ServerControlsOnly. This only affects the parse/persist of the content of the region.

// Create a simple column, click region at top and edit region below
regions = new DesignerRegionCollection( );
// Create editable region which describes its content as text and markup
regions.Add (new EditableDesignerRegion(
this, “body”, true));

If an EditableDesignerRegion describes its content as servercontrols then the framework will persist a string of content to a control or template and strip out any content that is not a server control.

Handling Events on Regions:

The ControlDesigner base class provides methods and properties to handle a number of events on the regions in a control designer's layout. The plumbing for raising the event on the control designer is provided through a View (IControlDesignerView) that is implemented by the designer-host. However, the events themselves are given top-level prominence in the control designer, so that control developers so not access or deal with the View.

During Initialization of the control designer the View is set.

Step 1: Control developers override the OnX event handler to provide specific design-time handling. This model circumvents the need for control developers to associate event handlers directly in their code. It does mean that all events are raised however, regardless of the need for them.

```
// -----------------------------------------------------------------------------
// Sample: Simple Column control that defines a column header that
// changes color based on a click
//
private System.Drawing.Color _headerColor =
System.Drawing.Color.White;
public override string GetDesignTimeHtml(DesignerRegionCollection
regions)
{
    String dtHtml;
    MyControl control = (MyControl)Component;
    regions.Add(new DesignerRegion(this, “Header”);
    regions.Add(new EditableDesignerRegion(this, “body”);
    // Build the rendering for the design-time.
    // The child controls are known to be table cells at
    // specific locations in the collection
    control.Controls[2].Attributes.Add(
      DesignerRegion.DesignerRegionAttributeName, “0”);
    control.Controls[2].BackColor = _headerColor;
    control.Controls[4].Attributes.Add(
      DesignerRegion.DesignerRegionAttributeName, “1”);
    dtHtml = base.GetDesignTimeHtml( );
    return dtHtml;
}
// -----------------------------------------------------------------------------
// Handle the OnClick event and change the color of the column header
protected override void OnClick(DesignerRegionEventArgs e)
{
    // Determine that the header was clicked
    _headerColor = System.Drawing.Color.White;
    if (e.Region.name == ‘Header”)
      _headerColor = System.Drawing.Color.LightRed;
    // Call the Update on the host
    UpdateDesignTimeHtml( );
}
```

Utilizing Services Offered by the Designer-Host

Designer-Host Developers

Much of the interaction model between the designer-host and control-developers is described above. The following exemplary additional features are described.

Calling on the Control Designer for Rendering:

Designer-hosts will call through the ControlDesigner.GetViewRendering method for all control designers.

Providing Plumbing for the Control Designer and Design-Surface:

IControlDesignerView:

Much of the low-level plumbing for the interaction between the design-surface and the control designer is handled through the tool's implementation of IControlDesigner View. This View raises events and provide UI services that are scoped to a particular control. The control designer contains an IControlDesigner View property

Control designers therefore can have windows-like functionality and have the ability to:
Indicate support for resizing, painting and whether it behaves as a drag/drop target.
Change the cursor or its visibility

The designer-host maps the implementation of this interface to its own implementation of the UI.

The ControlDesigner base class provides a virtual UpdateDesignTimeHtml( ) method. This internally calls back on the designer-host through View. Update. It is the tool's responsibility to perform callback on the control designer for new rendering.

Control developers may not use the View property, rather members are provided on the control-designer for interaction.

Providing Plumbing for the Control Designer and Control Persistence:

IControlDesignerTag:

By implementing IControlDesignerTag, the designer-host can offer persistence capabilities for the control designer. The control designer contains an IControlDesignerTag Tag property.

1. A method comprising:
receiving, by an interactive control designer, an event from a design surface, the event being associated with graphical elements of a designer region in a server control rendered by the design surface; and
handling, by the interactive control designer, the event.

2. A method as recited in claim 1, wherein the control designer implements and exposes functionality for the design surface to: get design-time data associated with the server control, identify each of one or more designer regions of the server control, get initial content or watermark data for each designer region, or set editable designer region content.

3. A method as recited in claim 1, wherein the event is caused by user interaction with the graphical elements.

4. A method as recited in claim 1, wherein the event is a selection, mouse move, or edit event.

5. A method as recited in claim 1, wherein the designer region implements and exposes functionality for the design surface to obtain name, dimension and position coordinates, content, or watermark text associated with the designer region.

6. A method as recited in claim 1, wherein the designer region implements and exposes functionality for the design surface to determine whether the designer region is directly editable, read-only, selectable, or highlight-able

7. A method as recited in claim 1, and further comprising communicating data associated with rendering information to the design surface, the data including information for the design surface to adorn the designer region for user interaction with the designer region.

8. A method as recited in claim 1, and further comprising:
communicating data associated with design-time markup to the design surface, the data including information identifying one or more event handlers implemented by the control designer to handle one or more types of events; and
wherein handling further comprises processing, by the one or more event handlers, the event.

9. A method as recited in claim 1, and further comprising communicating data associated with one or more attributes of the designer region to the design surface for presentation by the design surface with respect to the designer region, the presentation not being in a properties dialog window independent of the control designer.

10. A method as recited in claim 1, and further comprising communicating data associated with one or more attributes of the designer region to the design surface for presentation by the design surface with respect to the designer region, the presentation not being in a properties dialog window independent of the control designer, the data being content or watermark data.

11. A method as recited in claim 1:
wherein the event is an edit event, the edit event comprising new content directly input by a user of the design surface into respective ones of the graphical elements; and
wherein handling further comprises pushing the new content into a property of the designer region.

12. A computer-readable medium comprising computer-executable instructions for designer regions and interactive control designers, the computer-executable instructions comprising instructions for:
communicating data identifying interactive control designer implemented event handlers to a design surface, the event handlers for handling events directed to at least one property of one or more respective designer regions defined for a server control;
receiving, by at least one of the event handlers, an event from the design surface, the event being associated with graphical elements of one of the one or more respective designer regions rendered by the design surface; and
handling, by the at least one event handler, the event.

13. A computer-readable medium as recited in claim 12, wherein the data includes information for the design surface to adorn the designer region for user interaction with the designer region.

14. A computer-readable medium as recited in claim 12, wherein the design surface is a component of a forms designer application.

15. A computer-readable medium as recited in claim 12, wherein the interactive control designer implements and exposes functionality for the design surface to: get design-time data associated with the server control, identify each of one or more respective designer regions, get initial content or watermark data for each designer region, or set editable designer region content.

16. A computer-readable medium as recited in claim 12, wherein the event is caused by user interaction with the graphical elements.

17. A computer-readable medium as recited in claim 12, wherein at least one of the designer regions implements and exposes functionality for the design surface to obtain name, dimension and position coordinates, content, or watermark text associated with the designer region.

18. A computer-readable medium as recited in claim 12, wherein at least one of the designer regions implements and exposes functionality for the design surface to determine whether the designer region is directly editable, read-only, selectable, or highlight-able

19. A computer-readable medium as recited in claim 12:
wherein the event is an edit event, the edit event comprising new content directly input by a user of the design surface into respective ones of the graphical elements; and
wherein handling further comprises pushing the new content into a property of the designer region.

20. A computing device for designer regions and interactive control designers, the computing device comprising:
a processor; and
a memory coupled to the processor, the memory comprising computer-program instructions executable by the processor for:
communicating, by an interactive control designer, data associated with design-time markup to a design surface, the data allowing the design surface to render graphical elements of a designer region in a server control, the data comprising information for the design surface to adorn the designer region for user interaction with the designer region;
receiving, by one or more event handlers implemented by the interactive control designer, an event from application logic associated with the design surface, the event being associated with the designer region; and
processing, by the one or more event handlers, the event.

21. A computing device as recited in claim 20, wherein the data further comprises information corresponding to one or more attributes of the designer region for presentation by the design surface on the designer region, the presentation not being in a properties dialog window independent of the interactive control designer.

22. A computing device as recited in claim 20, wherein the data further comprises information corresponding to one or more attributes of the designer region to the design surface for presentation by the design surface with respect to the designer region, the presentation not being in a properties dialog window independent of the control designer, the data being content or watermark data.

23. A computing device as recited in claim 20, wherein the data further comprises information to identify the one or more event handlers for connecting, by the design surface, to respective user-based events.

24. A computing device as recited in claim 20, wherein the computer-program instructions further comprise instructions for exposing, by the interactive control designer, functionality for the design surface to: get design-time data associated with the server control, identify each of one or more designer regions of the server control, get initial content or watermark data for each designer region, or set editable designer region content.

25. A computing device as recited in claim 20, wherein the computer-program instructions further comprise instructions for exposing, by the designer region, functionality for the design surface to obtain name, dimension and position coordinates, content, or watermark text associated with the designer region.

26. A computing device as recited in claim 20, wherein the computer-program instructions further comprise instructions for exposing, by the designer region, functionality for the design surface to determine whether the designer region is directly editable, read-only, selectable, or highlight-able

27. A computing device as recited in claim 20:
wherein the event is an edit event, the edit event comprising new content directly input by a user of the design surface into respective ones of the graphical elements; and
wherein the computer-program instructions for handling further comprises instructions for pushing the new content into a property of the designer region.

28. A computer-readable medium comprising:
an interactive control designer object, the interactive control designer object comprising:
a first interface for an application to get design-time data for a server control, the server control comprising one or more designer regions; and
a second interface for the application to request the interactive control designer to handle an event associated with at least one of the one or more designer regions.

29. A computer-readable medium as recited in claim 28, wherein the application is a forms designer comprising a design surface.

30. A computer-readable medium as recited in claim 28, wherein the interactive control designer object further comprises a third interface for the application to get content or watermark text of the one or more designer regions of the server control.

31. A computer-readable medium as recited in claim 28, wherein the interactive control designer object further comprises a fourth interface for the application to set content of the one or more designer regions of the server control.

32. A computer-readable medium as recited in claim 28, wherein the one or more designer regions expose functionality for the application to obtain name, dimension and position coordinates, content, or watermark text associated with the designer region.

33. A computing device as recited in claim 28, wherein at least a subset of the one or more designer regions expose respective interfaces for the design surface to determine whether the designer region is directly editable, read-only, selectable, or highlight-able

34. A computing device comprising:
receiving means for receiving, by an interactive control designer, an event from a design surface, the event being associated with graphical elements of a designer region in a server control rendered by the design surface; and
handling means for handling, by the interactive control designer, the event.

35. A computing device as recited in claim 34, and further comprising:
providing means for the control designer to provide the design surface with design-time data associated with the server control, information for each of one or more designer regions of the server control, or initial content or watermark data for each designer region; and
setting means for the design surface to set content of an editable designer region.

36. A computing device as recited in claim 34, and further comprising obtaining means for the design surface to determine name, dimension and position coordinates, content, or watermark text associated with the designer region.

37. A computing device as recited in claim 34, and further comprising obtaining means for the design surface to determine whether the designer region is directly editable, read-only, selectable, or highlight-able

38. A computing device as recited in claim 34, and further comprising adorning means to adorn the designer region with characteristics renderable by the display surface with graphical element(s).
